(19) United States
(12) Patent Application Publication
(10) Pub. No.: US 2014/0083239 A1
(43) Pub. Date: Mar. 27, 2014

(54) STEERING APPARATUS

(71) Applicant: NIHON PLAST CO., LTD., Fujinomiya-shi (JP)

(72) Inventor: Naohiro FUJITA, Fuji-shi (JP)

(73) Assignee: NIHON PLAST CO., LTD., Fujinomiya-shi (JP)

(21) Appl. No.: 14/038,045

(22) Filed: Sep. 26, 2013

(30) Foreign Application Priority Data
Sep. 27, 2012 (JP) 2012-213973

(51) Int. Cl. B62D 1/06

(52) U.S. Cl. CPC B62D 1/06
USPC 74/558

(57) ABSTRACT

A steering apparatus includes a grip core and a rim part. The grip core has a cross-sectional area substantially constant in a longitudinal direction of the grip core. The rim part is molded by foaming of a material liquid in a mold, and configured to cover the grip core. A first portion of the rim part is smaller in cross-sectional area than a second portion of the rim part, wherein the mold includes a vent opening facing the first portion of the rim part during the molding of the rim part, wherein the mold includes a material liquid infusion opening facing the second portion of the rim part during the molding of the rim part, and wherein the material liquid is infused into the mold through the material liquid infusion opening, and allowed to flow toward the vent opening.

### BACKGROUND OF THE INVENTION

The present invention relates to a steering apparatus for a vehicle, such as an automobile, an aircraft, a ship or a railroad car.

Japanese Patent Application Publication No. 59-045275 discloses a steering apparatus produced by: setting a mold such that a material liquid infusion opening of the mold is located on a lower side and a vent opening of the mold is located on an upper side; installing an annular grip core whose cross-sectional area is relatively large at the vent opening and decreases toward the material liquid infusion opening; and infusing a material liquid into the mold through the material liquid infusion opening, to allow the material liquid to be molded by foaming in the mold.

### SUMMARY OF THE INVENTION

In the steering apparatus described above, the feature that the cross-sectional area of the grip core is set to increase gradually as followed from the material liquid infusion opening to the vent opening, may cause an increase of the weight of the steering apparatus due to the thick portion of the grip core, and also cause an increase of the manufacturing cost of the steering apparatus due to the varying cross-sectional area of the grip core. Moreover, if a rim part of the steering apparatus is made of a synthetic resin having a high specific gravity, foam occurring in the mold fails to exit through the vent opening due to shortage of foaming pressure. If this problem is addressed by selecting a synthetic resin capable of causing a high foaming pressure, it may cause the density of the synthetic resin of the rim part to become small.

In view of the foregoing, it is desirable to provide a steering apparatus which is capable of being produced with a light weight and a low manufacturing cost without adversely affecting the flow rate of gas in the mold and the efficiency of gas ventilation from the mold.

According to one aspect of the present invention, a steering apparatus comprises: a grip core whose cross-sectional area is substantially constant in a longitudinal direction of the grip core; and a rim part molded by foaming of a material liquid in a mold, and configured to cover the grip core, wherein a first portion of the rim part is smaller in cross-sectional area than a second portion of the rim part, wherein the mold includes a vent opening facing the first portion of the rim part during the molding of the rim part, wherein the mold includes a material liquid infusion opening facing the second portion of the rim part during the molding of the rim part, and wherein the material liquid is infused into the mold through the material liquid infusion opening, and allowed to flow toward the vent opening.

According to another aspect of the present invention, the steering apparatus is configured so that: the grip core has an annular wheel shape; the first portion of the rim part is provided with a spacer covering the grip core; and the spacer has a length covering a range of about 90 degrees around a center of the annular wheel shape of the grip core.

According to a further aspect of the present invention, the steering apparatus is configured so that the spacer includes a pair of parts sandwiching the grip core therebetween.

### BRIEF DESCRIPTION OF THE DRAWINGS

FIG. 1 is a front view of a steering apparatus according to an embodiment of the present invention.

FIG. 2 is a perspective view of the steering apparatus shown in FIG. 1, wherein a rim part is removed from the steering apparatus.

FIG. 3 is an exploded perspective view of a spacer shown in FIG. 2.

FIG. 4 is a cross-sectional view of the steering apparatus taken along a plane indicated by a line SA-SA in FIG. 1.

FIG. 5 is a cross-sectional view of the steering apparatus taken along a plane indicated by a line SB-SB in FIG. 1.

### DETAILED DESCRIPTION OF THE INVENTION

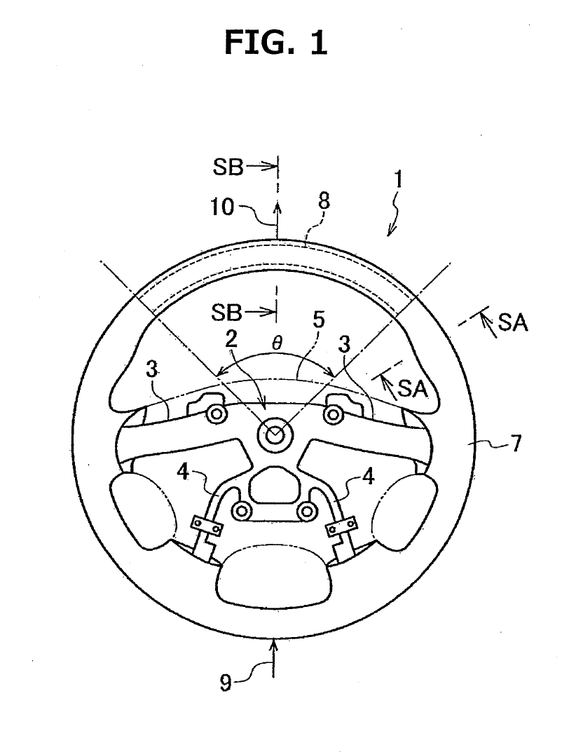

FIGS. 1 to 5 show a steering apparatus according to an embodiment of the present invention. A steering apparatus 1 is applied to an automobile in this embodiment. The steering apparatus 1 includes a boss part 2, a rim part 7, a pair of first spoke parts 3, 3, a pair of second spoke parts 4, 4, and a horn cover 5. The boss part 2 is adapted to be supported on a top end portion of a steering post not shown. The rim part 7 has an annular wheel shape surrounding the boss part 2. Each first spoke part 3 is formed by casting of magnesium, and configured to connect the boss part 2 and the rim part 7. Similarly, each second spoke part 4 is formed by casting of magnesium, and configured to connect the boss part 2 and the rim part 7. The horn cover 5 is configured to cover the boss part 2, the first spoke parts 3, 3, and the second spoke parts 4, 4, and cause a horn not shown to honk. Each first spoke part 3 extends from boss part 2 generally in the horizontal direction, whereas each second spoke part 4 extends from boss part 2 generally in the vertical direction, as viewed in FIG. 1 where the steering apparatus is in a neutral position or in a position where the steering apparatus is formed in a mold.

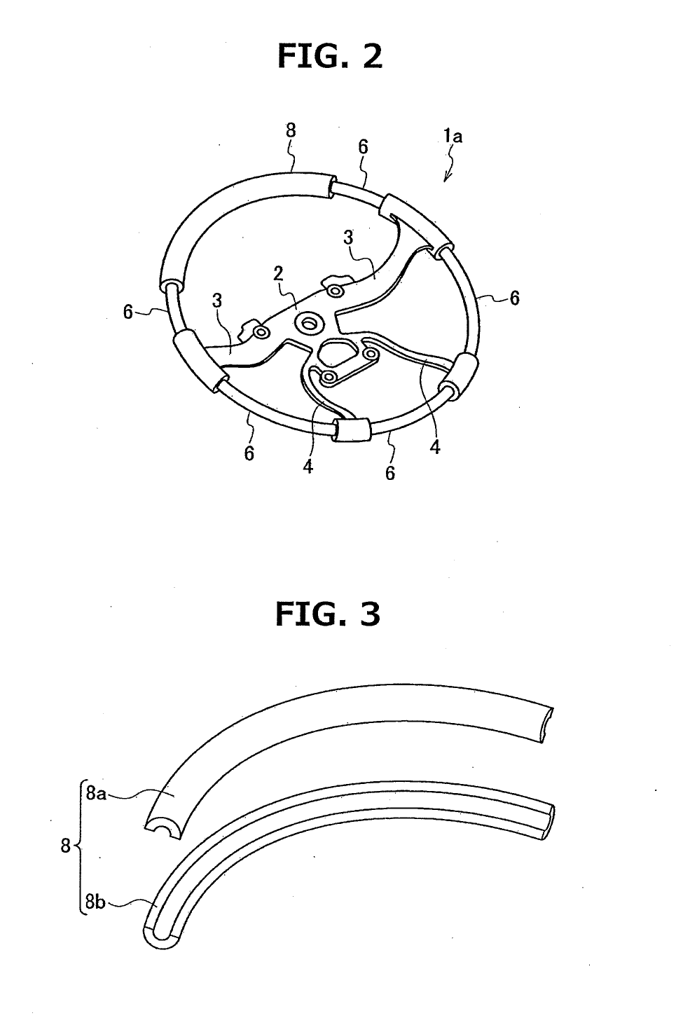

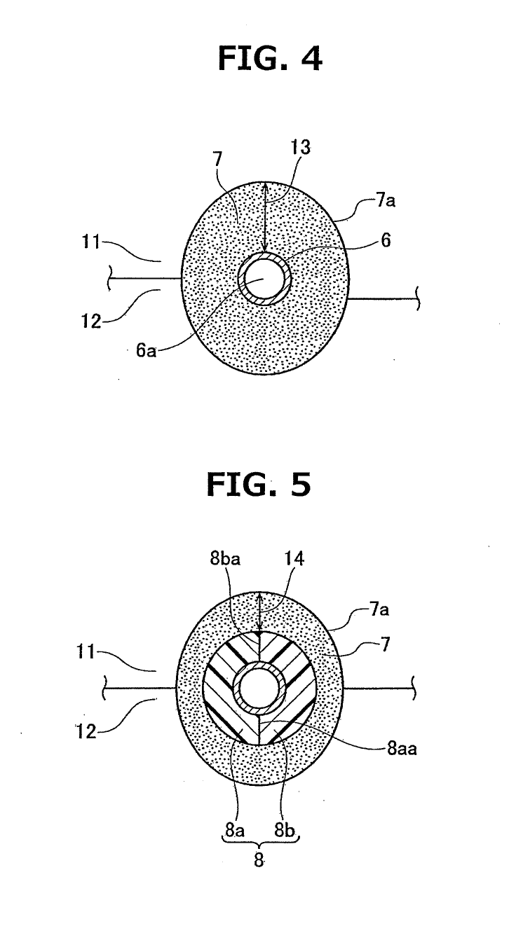

The rim part 7 is formed to cover a grip core 6 that is made of a hollow steel frame, and has an annular wheel shape surrounding the boss part 2 as shown in FIG. 2. The grip core 6 has a cross-sectional area that is substantially constant in a longitudinal direction of the grip core 6 as shown in FIGS. 4, 5. The grip core 6 has a hollow 6a at the center as shown in FIGS. 4, 5. While the rim part 7 is being formed, a material liquid infusion opening 9 of a mold (molds 11, 12) is located on the lower side, and a vent opening 10 of the mold is located, and the grip core 6 is set in a vertical position as shown in FIG. 2. This positional relationship may be modified if the material liquid infusion opening 9 is located at an upstream position in a flow of the material liquid, and the vent opening 10 is located at a downstream position in this flow. The grip core 6 is provided with a spacer 8 that is located at an uppermost portion of the grip core 6 faced by the vent opening 10. The spacer 8 is thus located at a most downstream position in the mold. The cross-sectional area of the spacer 8 is smaller than that of the rim part 7 in the cross-section of the grip core 6 as shown in FIG. 5. The spacer 8 is set to cover the grip core 6 as shown in FIG. 2. Under this condition, a material liquid such as polyurethane having a foaming factor of 2 is infused into the mold 11, 12 through the material liquid infusion opening 9, so that a space between an outer surface of the grip core 6 or the spacer 8 and an inner surface of the mold 11, 12 defining an outer surface 7a of the rim part 7 is filled with the material liquid. The material liquid flows in the mold 11, 12 from the lower side to the upper side, namely, from the upstream side including the material liquid infusion opening 9 to the downstream side including the vent opening 10. After foaming, the foamed product has a high density of about 0.8 to 0.85. The rim part 7 is thus formed to cover the grip core 6 and the spacer 8. The amount of the material liquid infused is determined to just reach the longitudinal ends of the spacer 8.

The spacer 8 is located at the upper portion of the grip core 6 facing the vent opening 10. The spacer 8 has a length covering a range of an angle θ that is equal to about 90 degrees range around the center of the annular wheel shape of the grip core 6 (or around the center of the boss part 2). The spacer 8 is composed of an upper spacer 8a and a lower spacer 8b which sandwich the grip core 6 therebetween. The spacer 8 is made of a synthetic resin such as an acrylonitrile butadiene styrene resin (ABS resin), which is not melted by contact with the material liquid (premixture to form polyurethane or the like in this example) at 100° C., but adhered to the formed product (polyurethane or the like). The upper spacer 8a has a semicircular cross-section having a semicircular recess directed downwardly. The lower spacer 8b has a semicircular cross-section having a semicircular recess directed upwardly. As shown in FIG. 5, the upper spacer 8a and the lower spacer 8b are joined to each other with an end surface 8aa of the upper spacer 8a being in contact with an end surface 8ba of the lower spacer 8b. The upper spacer 8a and the lower spacer 8b thus constitute a tubular shape of the spacer 8.

In the configuration described above, a material liquid including a foaming agent is infused through the material liquid infusion opening 9 under infusion pressure and made to fill the space between the inner surface of the mold 11, 12 and the grip core 6 or the spacer 8, and begins to be foamed, under the condition that the mold 11, 12 is set with respect to the grip core 6 such that the material liquid infusion opening 9 is located on the lower side and the vent opening 10 is located on the upper side. The annular wheel shape of the rim part 7 serves to allow the material liquid to flow smoothly. The provision of the spacer 8 causes a condition that the spacing 14 inside the inner surface of the mold 11, 12 at the place where the spacer 8 is provided is smaller than the spacing 13 inside the inner surface of the mold 11, 12 at the normal place where the spacer 8 is not provided. For example, the spacing 13 is equal to 12.4 mm, whereas the spacing 14 is equal to 7.65 mm. During the infusion of the material liquid, the flow rate of the material liquid rises quickly at the boundary between the place where the spacer 8 is provided and the place where the spacer 8 is not provided. This serves to quickly complete the filling up to the upper side of the grip core 6, and allow bubbles contained in the flow of the material liquid to quickly flow out through the vent opening 10, thus improving the efficiency of gas ventilation. The feature that the cross-sectional area of the grip core 6 is substantially constant in the longitudinal direction serves to reduce the weight of the steering apparatus 1, and reduce the manufacturing cost. The spacing 13 constitutes a thick part of the rim part 7, whereas the spacing 14 constitutes a thin part of the rim part 7.

The feature that the spacer 8 extends over the range of 90 degrees around the center of the annular wheel shape of the grip core 6 which range faces the vent opening 10 of the mold 11, 12, serves to allow the gas to be ventilated effectively through the vent opening 10 which gas is generated by foaming of the material liquid infused through the material liquid infusion opening 9, and thereby prevent the surface of the rim part 7 from being formed with projections and depressions (namely, voids) resulting from the remaining gas.

The feature that the spacer 8 is composed of the upper spacer 8a and the lower spacer 8b which sandwich the grip core 6 therebetween, serves to make it very easy to assemble the spacer 8 with the grip core 6.

The present embodiment may be modified in various manners as follows. Although the steering apparatus is applied to the automobile in the present embodiment, the steering apparatus may be applied to another type of vehicle such as an aircraft, a ship, or a railroad car. Although the feature that the cross-sectional area of the portion of the rim part 7 facing the vent opening 10 is smaller than the other part of the rim part 7 is implemented by the provision of the spacer 8, this feature may be implemented by different means. Although the spacer 8 is made of an ABS resin in the present embodiment, the spacer 8 may be made of polypropylene, or may be made by casting of magnesium simultaneously with the forming of the first spoke parts 3, 3 and the second spoke parts 4, 4 made of magnesium. However, the ABS resin is advantageous in cost. Although the grip core 6 is made of a hollow steel frame in the present embodiment, the grip core 6 may be made of only magnesium.

The entire contents of Japanese Patent Application 2012-213973 filed Sep. 27, 2012 are incorporated herein by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A steering apparatus comprising:
a grip core whose cross-sectional area is substantially constant in a longitudinal direction of the grip core; and
a rim part molded by foaming of a material liquid in a mold, and configured to cover the grip core, wherein a first portion of the rim part is smaller in cross-sectional area than a second portion of the rim part, wherein the mold includes a vent opening facing the first portion of the rim part during the molding of the rim part, wherein the mold includes a material liquid infusion opening facing the second portion of the rim part during the molding of the rim part, and wherein the material liquid is infused into the mold through the material liquid infusion opening, and allowed to flow toward the vent opening.

2. The steering apparatus as claimed in claim 1, wherein:
the grip core has an annular wheel shape;
the first portion of the rim part is provided with a spacer covering the grip core; and
the spacer has a length covering a range of about 90 degrees around a center of the annular wheel shape of the grip core.

3. The steering apparatus as claimed in claim 2, wherein the spacer includes a pair of parts sandwiching the grip core therebetween.
